(19) United States
(12) Patent Application Publication
(10) Pub. No.: US 2010/0138171 A1
(43) Pub. Date: Jun. 3, 2010

(54) PRESSURE SENSING METHOD AND SYSTEM FOR FLEXIBLE AERODYNAMIC SURFACES

(75) Inventors: David George, Delta (CA); Greg Burley, Delta (CA)

Correspondence Address: FASKEN MARTINEAU DUMOULIN LLP, 2900 - 550 Burrard Street, VANCOUVER, BC, V6C 0A3, CA

(73) Assignee: SAILMETER INC., Delta, BC (CA)

(21) Appl. No.: 12/594,318

(22) PCT Filed: Apr. 3, 2008
(86) PCT No.: PCT/CA08/00645

§ 371 Date: Oct. 1, 2009

Related U.S. Application Data
(60) Provisional application No. 60/909,882, filed on Apr. 3, 2007.

(51) Int. Cl. G01M 9/06; G01L 13/00; G01L 7/00

(52) U.S. Cl. 702/50; 73/714

(57) ABSTRACT

An apparatus for measuring aerodynamic performance is provided, including a batten; a plurality of pressure differential sensors positioned on the batten, each of the sensors having a first port for exposure to a first pressure and a second port for exposure to a second pressure; and a plenum positioned so that each of the first ports is exposed to a pressure within the plenum. The batten is positioned on a sail. The sensors may be in communication with a computer and the sensors may be networked in an asymmetric daisy chain network for uplink communications from the computer and networked in parallel as a bus for downlink communications to the computer.

This application claims the benefit of U.S. Provisional Patent Application No. 60/909,882 filed Apr. 3, 2007, which is hereby incorporated by reference.

### FIELD OF THE INVENTION

This invention relates to systems and methods of measuring aerodynamic performance of flexible surfaces such as sails, and more particularly to measuring aerodynamic performance using sensors.

### BACKGROUND OF THE INVENTION

A problem when measuring aerodynamic performance of surfaces such as sails is the inability to quantitatively measure the full scale, real-time aerodynamic performance. Some prior art attempts to solve this problem include a differential pressure sensor and sail equipped with such a sensor as disclosed in FR2633717, and a sailboat and crew performance optimization system as disclosed in U.S. Pat. No. 6,308,649.

FR2633717 discloses a sensor intended to measure the difference in pressure of two opposing sides of the sail of a ship or the like. The pressure difference is measured at one point on the surface of the sail by creating a hole through the sail and attaching a specific sensor device at that hole. No reference measurements are used.

U.S. Pat. No. 6,308,649 to Gedeon discloses the addition of feedback system to improve yacht function. A number of sensor systems (such as for tracking wind flow using sail sensors) are connected to an analysis function to improve the yacht performance.

Sensors have been used in the prior art to measure sail performance. One method of using sensors for this purpose is to connect a string of multiple sensors along a sail in a symmetric network, in which the uplink and downlink communications are organized as a bus and the sensors are connected in parallel. In addition, each sensor node receives an enable signal from a master node allowing the master to address and configure each sensor individually if necessary, and enabling each sensor individually on the downlink bus when collecting the data. A problem with this configuration is that as the number of sensors grows, the number of enable signals (and wires) grows as well. For larger networks, the bundle of enable signal wires rapidly becomes undesirable.

To avoid the requirement that an enable signal be sent to each sensor, each sensor could be preconfigured with an address using a software ROM, DIPswitch or jumper-wire preset. An undesirable side effect of this preconfiguration is that it places a burden on the operator to ensure the network is configured correctly. As the sensors may not be identical, this requires additional skill in the replacement of a sensor or the maintenance of the network.

Another alternative in the prior art is to connect the sensors in a string using USB or IEEE1394 (Firewire). This requires significant overhead in terms of hardware and software to implement the protocol, and has significant power requirements.

### BRIEF SUMMARY OF THE INVENTION

The system according to the invention provides several features not present in the prior art, including that sensors are positioned on or within a batten, and are not directly secured to the sail. The batten can be easily added or removed from the sail without damage to the sail. A reference pressure plenum can be shared within the batten, between battens or between sails. Data from the battens can be transmitted wirelessly (a wired backup may also be used) to the accompanying software application and/or receiving system.

Given a number of sensors on the batten, an efficient means of organizing a network to connect the sensors should be used. Such a network should be capable of sending commands to the sensors, and returning the sensor data in an organized fashion to a master data-gathering node. In particular, it is advantageous for each sensor in the network to be identical, for the network to be self-organizing, and for the interconnecting hardware (wires, connectors, etc) to be minimized for robustness in a harsh environment.

An asymmetric daisy chain network provides a means of connecting a number of sensor nodes into a network, with a master data-gathering node. The network is asymmetric in that the uplink from the master to the sensor nodes is connected in series as a daisy chain, while the downlink is connected in parallel as a bus. This configuration allows the master node to initialize each sensor node in turn, assigning each sensor a number and a time-slot on the downlink bus. At the end of initialization, the master has a count of the number of sensors, and is able to broadcast commands to all enabled sensors simultaneously. Each slave sensor has a time-slot on the data bus to return its sensor data without collisions with the other sensors. This particular arrangement results in a simple interconnect, with a minimal number of wires.

Such a network arrangement provides several advantages, including:

a) all of the sensors are functionally the same, in both hardware and software, thus there are no configuration devices such as ROMs, DIPswitches, or jumper-wires to preset;
b) the interconnect between sensors is simple, requiring a minimal number of wires;
c) the network is self-organizing. A simple initialization protocol assigns each sensor a number and a time-slot on the data bus, and gives the master a count of the number of sensors; and
d) after initialization, the master is able to broadcast commands to all sensor nodes simultaneously. The sensor nodes are able to share the data bus using time-division multiplexing.

An apparatus for measuring aerodynamic performance is provided, including a batten; a plurality of pressure differential sensors positioned on the batten, each of the sensors having a first port for exposure to a first pressure and a second port for exposure to a second pressure; and a plenum positioned so that each of the first ports is exposed to a pressure within the plenum. The batten may be positioned on a sail. The sensors may be in communication with a computer and the sensors may be networked in an asymmetric daisy chain network for uplink communications from the computer and networked in parallel as a bus for downlink communications to the computer.

The sensors may be positioned within the batten, and the plenum may be positioned within the batten. The sensors may be wirelessly in communication with the computer or wired to the computer.

A flexible aerodynamic surface (such as a sail), is provided, including a batten; a plurality of pressure differential sensors positioned on the batten, each of the sensors having a first port for exposure to a first pressure and a second port for exposure to a second pressure; and a plenum positioned so that each of the first ports is exposed to a pressure within the plenum. The surface may have a plurality of battens on which a plurality of sensors are positioned, and each of the battens has a plenum.

A system for evaluating sail pressure is provided, including a computer; a plurality of sensors, each of the sensors having a first port for exposure to a first pressure and a second port for exposure to a second pressure; and a batten, the batten containing a plenum and the plurality of sensors; wherein the sensors are networked in an asymmetric daisy chain when receiving communications from the computer and the sensors are networked in parallel as a bus for transmitting communications to the computer. The sensors may include a plurality of slave nodes. Each communication from the computer may be received by a master node, and the master node sends the communication to a first slave node, and the first slave node, if the communication is intended for another slave node, sends the communication to a second slave node.

### DESCRIPTION OF THE FIGURES

FIG. 1 is a side view of a sail showing a batten according to the invention;

FIG. 2 is a top view of a sail showing a plenum and batten alongside the sail according to the invention;

FIG. 3 is a cutaway front view of a sail showing the sensor, plenum and batten according to the invention;

FIG. 4 is a side view of a sail showing the position of the battens according to the invention;

FIG. 5 is a side view showing an alternative positioning of the battens thereof; and

FIG. 6 is a block diagram of the computer system according to the invention;

FIG. 7 is a flow chart showing the process by which the sensors are initialized.

### DETAILED DESCRIPTION OF THE INVENTION

This system and method according to the invention enables full-scale real-time aerodynamic pressure to be measured on a flexible surface such as sail 10. The system comprises two main components: a plurality of sensors 20 with means to position the sensors, such as batten 30; and software related to managing, analyzing and displaying the measurements from sensors 20.

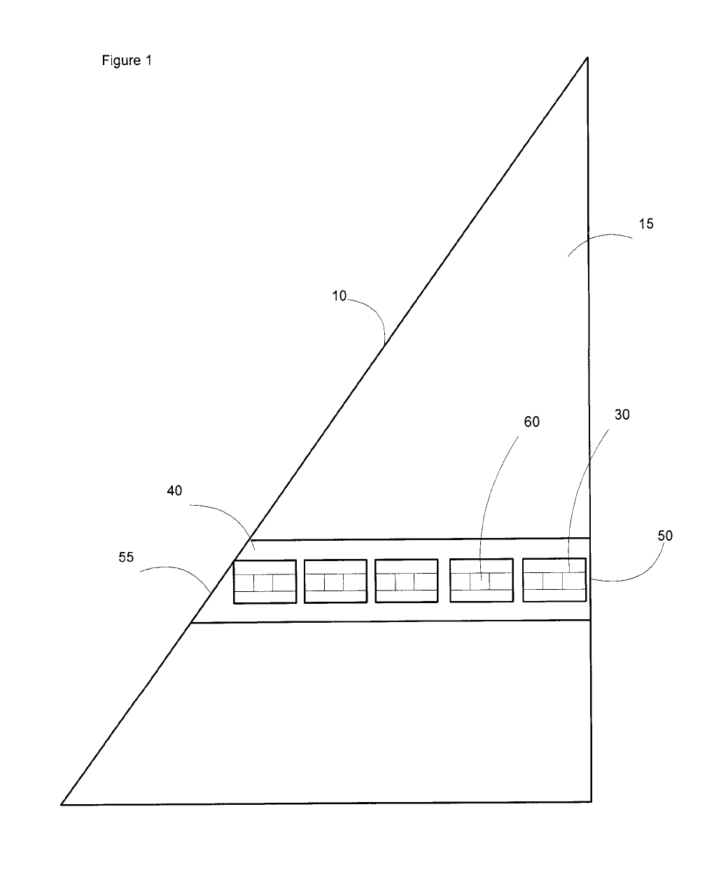

Batten 30 is a flexible tube like structure, which easily conforms to the shape of the surface 15 of sail 10, as seen in FIG. 1. Batten 30 may be made of plastics or composite materials. Batten can be attached to the surface 15 by means of a batten pocket 40, or tape or stitching in a similar manner as prior art battens. Batten pocket 40 may be a material sleeve sewn onto sail 10, which allows batten 30 to be easily slid into sail 10 and secured. Batten pocket 40 contains apertures for sensors 60 to be exposed to exterior pressure. Alternatively, the batten may be secured to the sail using tape or sewn directly to the sail. At the luff end of pocket 40 may be socket 50 that receives batten 30, and at the open end of pocket 40 is means 55 for securing batten 30 to prevent batten 30 from sliding out of pocket 40, using Velcro arrangements, ties, or the like. This provides means for easily adding or removing batten 30 from sail 10. Batten pockets 40 can also be added or removed without damage to sail 10. Thus the components of the batten hardware can be applied to sail 10 without damaging or putting holes through sail 10 and battens 30 can be removed from sail 10 so that sail 10 can be folded and stored in the traditional manner. Also battens 30 can easily be inserted into a different sail.

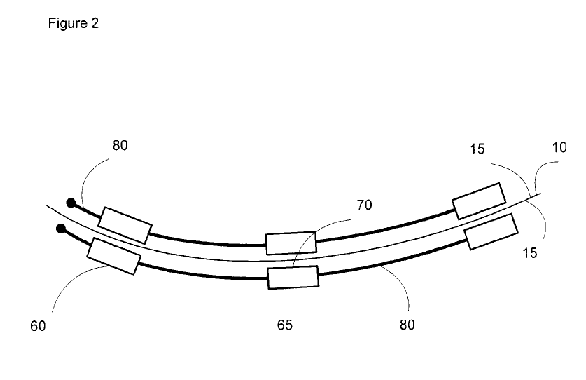

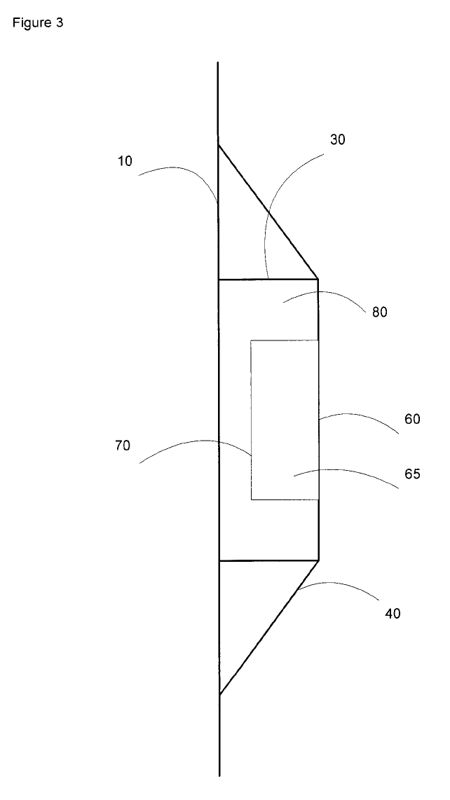

As seen in FIGS. 2 and 3, sensors 60 are attached to batten 30 such that a first port 65 of the differential pressure-sensing element is exposed to the local pressure on sail 10, while a second port 70 is exposed to a reference pressure. The reference pressure is communicated along batten 30 by means of plenum 80. Each sensor 60 on batten 30 has a first port 65 exposed to reference pressure plenum 80. Therefore, the differential pressure measured by each sensor 60 along batten 30 reflects the difference between the local pressure and the reference pressure.

Sensors 60 can be arranged along batten 30 to provide a distribution of pressures along batten 30 so that sensors 60 can identify the salient aerodynamic features. This may require one sensor 60, or it could require a plurality of sensors 60 on batten 30. There is no logical limit to the number of sensors 60 positioned on batten 30.

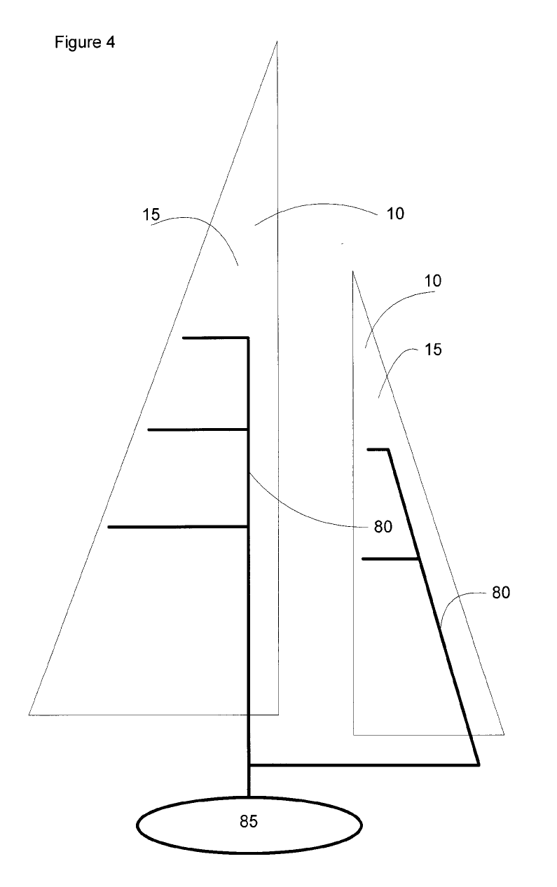

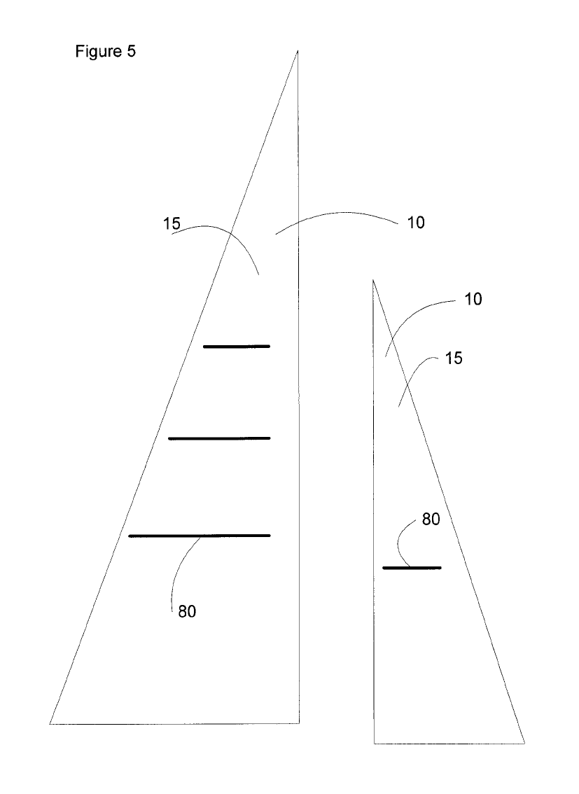

As each batten 30 measures pressure on only one surface 15, multiple battens 30 (each with multiple sensors 60) can be added to sail 10 so that pressures on both surfaces 15 and at different places on sail 10 can be measured. Examples of different configurations of battens are shown in FIGS. 4 and 5, in which plenum 80 receives a constant pressure from source 85. In FIG. 2, as an example of multiple battens on sail 10, battens 30 are placed on opposite surfaces 15 of sail 10. In this case, the reference pressure can either be: communicated between the battens by means of a common plenum 80; or can be measured independently and the results adjusted later, using the software. In the first case, plenums 80 are physically connected, as seen in FIG. 4, ensuring all battens 30 on the plenum 80 have the same reference pressure. In the second case, as seen in FIG. 5, the absolute pressure in each plenum 80 is measured independently and the software is used to translate the results to a common datum. In addition, if more than one sail 10 is being analyzed, multiple battens 30 can be used on each of sail 10 so that the total aerodynamic field on the system of sails 10 can be measured.

Each batten 30 is capable of communicating via wireless transmission with the software application or receiving system. Alternatively, the battens may be wired to communicate information to the software application or receiving system.

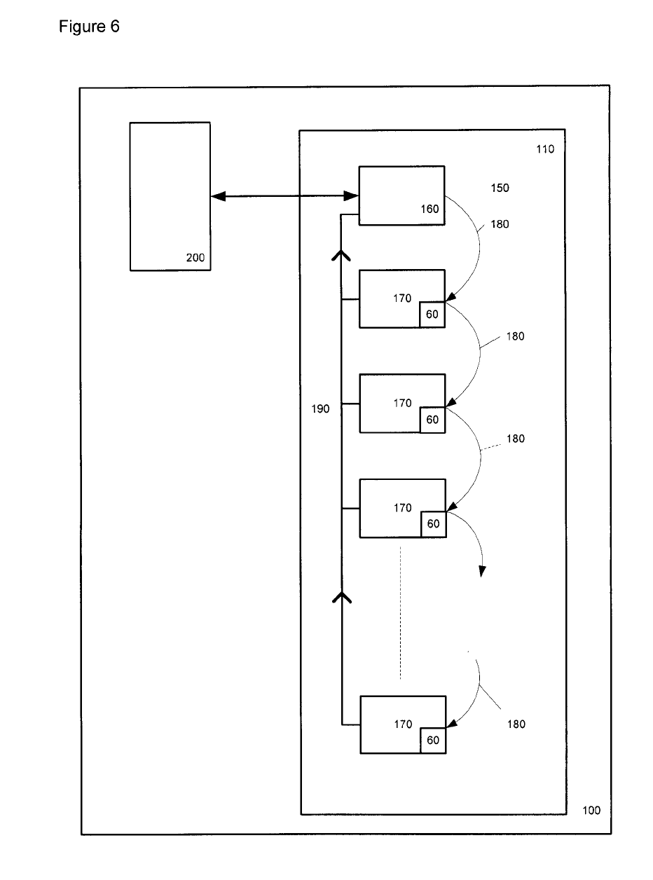

As seen in FIG. 6, system 100 requires two distinct components. A first component is the application(s) 110 used by the sensors 60 to manage the communications between the sensors 60 and software 200, and the second component is the application software 200 to receive and process the input from the sensors 60. The code used by the sensors includes an asymmetric daisy-chain sensor network 150. The term uC, as used herein, refers to a micro-controller at the node.

The asymmetric daisy-chain network 150 includes master node 160, also referred to as a “batten master”, which communicates with the sensors 60 and application software 200, and multiple slave nodes 170, with one slave node 170 at each sensor 60. The connection between master node 160 and application 200 may be a standard communications link. The connection between nodes is configured as a daisy chain 180 for the uplink communications from application 200, and a bus 190 for the downlink communications to application 200.

The uplink is configured as a daisy chain 180 with each node wired in series. Therefore, the uplink signal from master node 160 is received by each slave node/sensor 170, and then relayed to the next upstream node 170. The uplink is used to pass commands from the master node 160 uC to each of the slave node 170 uCs.

The downlink is configured as a bus 190, with each node 170 wired in parallel. Sharing of the bus is accomplished using time-division-multiplexing, where each of the slave nodes 170 is allocated a time-slot for putting its data on the bus. The downlink is used to pass data from the slave node 170 uCs (i.e. sensor nodes) to the master node 160 uC.

The key advantages to the daisy-chain uplink are that it: (a) minimizes the number of wires involved for the slave(s) nodes 170; and (b) allows for ‘smart’ initialization where each slave node 170 (in turn) is assigned a number and associated time-slot on the downlink bus 190.

### Initialization

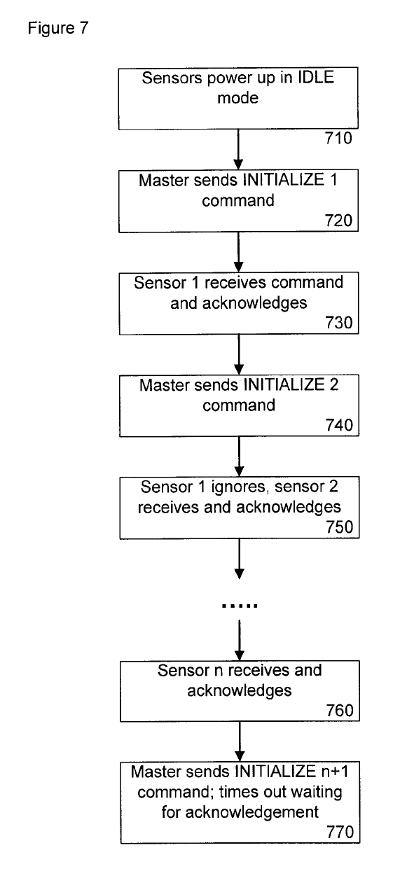

As seen in FIG. 7, the sensor network initialization is an iterative process. The goal is for each sensor 60 to discover its position in the daisy chain 180 by listening for an INTIALIZE command from the master 160, with an associated number.

In step 710, each sensor 60 in the daisy-chain 180 powers up in IDLE mode, programmed to listen but not to relay any received commands.

In step 720, master 160 sends out an INITALIZE 1 command, and only the first sensor 60 on the daisy chain 180 receives the command, in step 730 (since relaying is not yet enabled). So, the first sensor 60 knows it is in position 1. It enables relaying, sets a flag to ignore subsequent INTIALIZE commands, and sends an ACK back to the master.

The master 160 then sends out an INITIALIZE 2 command in step 740, and the command propagates to the second sensor 60, in step 750 but no further. The second sensor 60 now knows it is in position 2. It enables relaying, sets the initialization done flag, and sends an ACK back to the master 160.

The process repeats until the last sensor (sensor n) acknowledges (step 760), after which there is no ACK, and the master 160 times out waiting for the response (step 770). The master 160 now knows how many sensors 60 are in the network, and each slave 170 knows its number (which determines its time-slot).

### Operation

In operation, the master 160 will send out a SAMPLE command for the slaves/sensors 170 to sample the pressure and do an analogue to digital conversion. The master 160 then listens on the bus 190. Each of the sensors 60 starts a timer when it gets the SAMPLE command, and waits for its timeslot, then transmits its data. For instance, if the timeslots were 5 ms, sensor number 3 would wait 10 ms for its turn to transmit to avoid conflicts on the data bus 190.

On the receiving end, the master 160 then collects the raw data from each sensor 60, and stores the data in memory. When requested, master 160 packetizes the data with a short header and a CRC, and forwards it to the data acquisition computer running application 200. Other commands that may be communicated between application 200 and master node 160 and slave nodes 170 relate to calibration of the sensors, recovery of information and data, and other operating instructions. The computer may be a conventional computer with input and output means, a memory, and a processor.

### Software Application.

The software application 200 is capable of receiving the data generated by the sensor network, storing this data, and presenting it in a variety of formats.

The data can be used to provide real-time indication of sail performance; enable the identification of incremental performance improvements through quantitative, iterative learning (the scientific method); and thus can be used to improve race results. For sail makers, the system can be used to easily assess sail performance characteristics; validate sail design expectations; differentiate services from competitors; encapsulate intellectual property; and increase quality and uniformity of sail performance assessment throughout organization. For large sailing vessels, the system can be used to provide an electronic assessment of sail performance; provide an input to drive sail control systems; enable automated sail trim; and enable optimized sail performance.

The system can be used to combine the analysis of multiple sail interactions simultaneously, and the software can analyze, identify and isolate independent variables.

Although the particular preferred embodiments of the invention have been disclosed in detail for illustrative purposes, it will be recognized that variations or modifications of the disclosed apparatus lie within the scope of the present invention.

The invention claimed is:

1. An apparatus for measuring aerodynamic performance, comprising:
a) a batten;
b) a plurality of pressure differential sensors positioned on said batten, each of said sensors having a first port for exposure to a first pressure and a second port for exposure to a second pressure; and
c) a plenum positioned so that each of said first ports is exposed to a pressure within said plenum.

2. The apparatus of claim 1 wherein said batten is positioned on a sail.

3. The apparatus of claim 1 wherein said sensors are in communication with a computer.

4. The apparatus of claim 3 wherein said sensors are networked in an asymmetric daisy chain network for uplink communications from said computer.

5. The apparatus of claim 3 wherein said sensors are networked in parallel as a bus for downlink communications to said computer.

6. The apparatus of claim 1 wherein said sensors are positioned within said batten.

7. The apparatus of claim 6 wherein said plenum is positioned within said batten.

8. The apparatus of claim 3 wherein said sensors are wirelessly in communication with said computer.

9. The apparatus of claim 3 wherein said sensors are wired to said computer.

10. A flexible aerodynamic surface, comprising:
a) a batten;
b) a plurality of pressure differential sensors positioned on said batten, each of said sensors having a first port for exposure to a first pressure and a second port for exposure to a second pressure; and
c) a plenum positioned so that each of said first ports is exposed to a pressure within said plenum.

11. The surface of claim 10 further comprising a plurality of battens on which a plurality of sensors are positioned, and each of said battens having a plenum.

12. A system for evaluating sail pressure, comprising:
a) a computer;
b) a plurality of sensors, each of said sensors having a first port for exposure to a first pressure and a second port for exposure to a second pressure;
c) a batten, said batten containing a plenum and said plurality of sensors;
wherein said sensors are networked in an asymmetric daisy chain when receiving communications from said computer and said sensors are networked in parallel as a bus for transmitting communications to said computer.

13. The system of claim 12 wherein when said sensors include a plurality of slave nodes.

14. The system of claim 13 wherein each communication from said computer is received by a master node, and said master node sends said communication to a first slave node.

15. The system of claim 14 wherein said first slave node, if said communication is intended for another slave node, sends said communication to a second slave node.
